(19) United States
(12) Patent Application Publication
(10) Pub. No.: US 2025/0361127 A1
(43) Pub. Date: Nov. 27, 2025

(54) WINCH HANDLE FOR SAILBOAT WINCHES

(71) Applicant: Proxdrive AS, Fornebu (NO)

(72) Inventors: Petter Muren, Fornebu (NO); Martin Rishovd, Oslo (NO)

(73) Assignee: Proxdrive AS, Fornebu (NO)

(21) Appl. No.: 18/867,023

(22) PCT Filed: May 30, 2023
(86) PCT No.: PCT/EP2023/064384

§ 371 Date: Nov. 19, 2024

(30) Foreign Application Priority Data
May 30, 2022 (NO) 20220620

(51) Int. Cl. B66D 1/74

(52) U.S. Cl. CPC B66D 1/7473

(57) ABSTRACT

A winch handle (10, 20) locking system comprising a winch handle (10, 20) with a bit (11, 22) adapted to mate with a socket (11, 12) in a winch (10). The bit (11, 22) employs a first magnetic member, a magnet guide (23), interacting with a second magnetic element, a permanent magnet (12), inside the socket (11, 12). The magnet is fixed to the winch (10) at a position allowing the winch handle bit (22) to mate with the socket (11, 12) and securing a desired attraction force between the winch (10) and the winch handle (10, 20). Furthermore, a magnetic sensor (25) is placed at the magnet guide (23) in the bit (11, 22) and sends a trigger signal to electronics in the winch handle (10, 20) when the bit (11, 22) is fully mated into the socket (11, 12). An NFC antenna (24) in the bit (11, 22) is tuned to pick up a unique signal from an NFC tag (14) inside the socket (11, 12) of the winch (10) to allow the electronics in the winch handle (10, 20) to uniquely control a motor connected to the winch (10).

### FIELD OF THE INVENTION

The present invention relates to a winch handle for operating sailboat winches. More particularly, the present invention relates to a magnetic locking system for the winch handle, securing that the winch handle does not unintentionally comes loose from the winch it is temporarily mounted on. Furthermore, this winch handle is well suited for being modified to control power assisted winches.

### BACKGROUND OF THE INVENTION

Winches are typically used for pulling in lines attached to sails on sailboats or lines and ropes on other boats. They are normally operated manually by a winch handle that through gears in the winch rotates the winch drum that pulls in the lines. Specially on larger boats the force needed to operate a winch can be substantial and several applications of electric motors have been utilized to drive winches.

The Norwegian patent application 20211081 describes a power assist system that is operated with a winch handle equipped with sensors and wireless communication means. The control electronics integrated in the winch handle has features that temporarily links it to a motor controller in the power assist system for the winch that the winch handle is currently mounted on. This feature enables a single winch handle to be used on several different winches employing the mentioned invention without the danger of the winch handle unintentionally starting the motor in other systems. The winch handle of this invention also has other features that increase the safety and the ease of use, but to activate the different features and the operation of the winch handle it relies on input signals or activation signals given through flipping a knob. This knob-operation slows down and complicates the use of the winch handle.

When operating sailboat winches it is important to be able to remove the handle from the winch and then quickly put it back onto the winch again, e.g. during maneuvers where the sail sheets (lines) are frequently removed from the winch and another sheet is put on the same winch. Furthermore, it is important that the winch handle is locked or securely attached to the winch to prevent it from coming loose and possibly be lost overboard into the water.

There are several solutions to locking the handle to the winch. In U.S. Pat. No. 7,114,705, Steiner describes a winch handle with a locking system that is operated by pressing down a spring-loaded leaver on the top of the winch handle. The lock may be operated by one hand, squeezing down the leaver at the same time as the winch handle “bit” is mated with the “socket” on top of the winch. When you let go of the winch handle lock-pins at the tip of the bit engages with a void in the socket to prevent the handle from being removed from the winch. This locking system is, however, not suited in combination with the electronics described above as the mechanism takes up much of the space in the winch handle.

Typical industry standard winch handles have a slightly different locking system operated by a rotating knob placed vertically over the winch handle bit. The knob rotates a spring-loaded locking plate at the very lower end of the winch handle bit to align the projected shape of the locking plate with the shape of the bit, thus allowing the winch handle to be released from the winch socket. This solution is, however, even more cumbersome to operate than the locking mechanism described by Steiner.

In U.S. Pat. No. 6,491,285 Tomita describes a system where the locking plate is a fixed part of the winch handle bit and does not need any manual input to be engaged or unlocked. Instead, the shape of the winch handle bit is modified to allow the bit to tilt inside the winch socket during operation, and then (hopefully) shift the locking plate into the previously described void in the winch socket to secure the handle to the winch. The projected shape of the locking plate and the upper end of the bit is identical, allowing the winch handle bit to be moved freely up and down in the winch socket as long as the handle (and bit) is not tilted. In practical use this solution is unfortunately not working as good as intended and it is not in widespread use.

The present invention overcomes the problems and shortcomings of the winch handles described above by suggesting a new winch handle with a magnetic locking system that has no moving parts and require no additional movements or operations from the operator to lock or release it from the winch. The present invention may also include magnetic sensors that automatically activates the electronics in case the winch handle is adapted to control a winch motor.

### SUMMARY OF THE INVENTION

A winch handle locking system comprising a winch handle with a winch handle bit protruding down from an inner end of the winch handle. The winch handle bit is adapted to mate with an industry standard socket on top of a winch for sailboats. At its lower end, the winch handle bit employs a first magnetic member modified to magnetically interact with a second magnetic member inside the socket of the winch. The second magnetic member is further being mechanically fixed to the winch at a position allowing the winch handle bit to mate with the socket, and where the position of the second member and the magnetic properties of the first and the second magnetic members are further being tuned to secure an magnetic attraction force between the winch and the winch handle of between 10N and 60N when the winch handle is mounted on the winch. In the preferred embodiment of the present invention, the first magnetic member is a magnet guide comprising a magnetic conductive material and the second magnetic member is a permanent magnet. The magnet guide is further interacting with a magnetic sensor mounted inside the winch handle bit. The properties of the magnet guide and the characteristic of the magnetic sensor is adjusted to trigger the sensor when the winch handle bit is fully mated into the socket of the winch. The winch handle of the preferred embodiment of the present invention comprises electronics to control a motor connected to the winch and the operation of the electronics is furthermore activated by an electric signal sent from the magnetic sensor when it is triggered. Finally, the winch handle bit comprises an NFC antenna tuned to activate and pick up a unique signal from an NFC tag mounted together with the second magnetic device inside the socket of the winch to give information to a radio transmitting and receiving part of the electronics in the winch handle, to uniquely control the motor connected to the winch.

### BRIEF DESCRIPTION OF THE DRAWINGS

For the purpose of illustrating the present invention, a preferred embodiment is shown, however, this invention is not limited to the precise arrangements and design shown in the figures.

FIG. 1 shows a perspective view of the present invention.

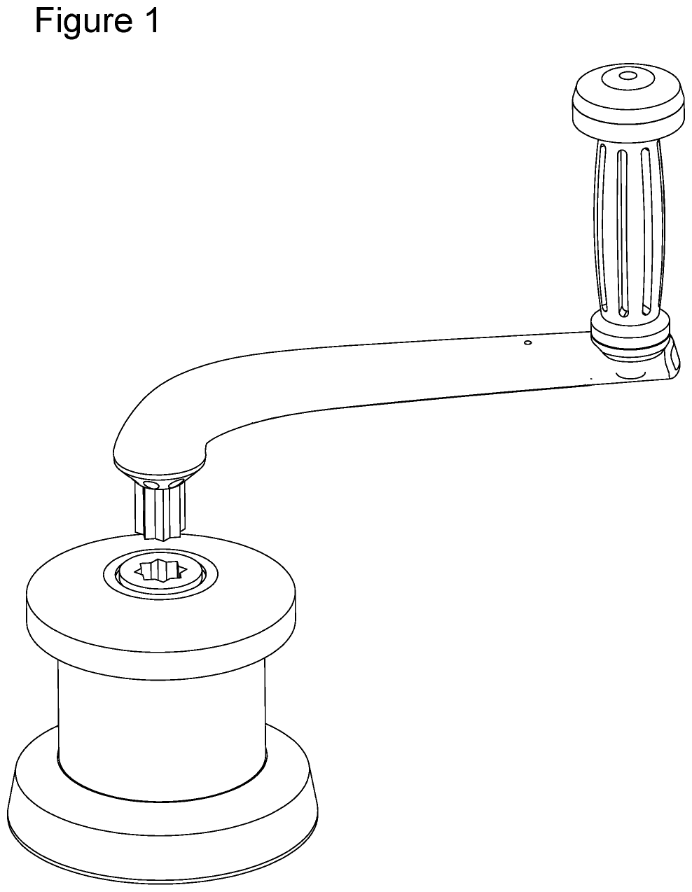

FIG. 2 shows a partly exploded perspective view seen from above, showing elements of the present invention.

FIG. 3 shows a full, cut through, section view seen from the side, showing all the elements of the present invention.

FIG. 4a, 4b, 4c shows the main elements of the present invention in perspective and cut through section views.

### DETAILED DESCRIPTION OF THE PREFERRED EMBODIMENT

Referring to the drawings, the layout and elements of a winch handle locking system according to the present invention is shown. The system is typically used together with an industry standard winch that preferably is mounted on a sailboat to haul in sail sheets, lines and ropes, but the invention may have application in many other areas as well.

The locking system is shown and described in a winch handle adapted for controlling the motor in a power assist system connected to the winch. The Norwegian patent application 20211081 describes one such possible power assist system.

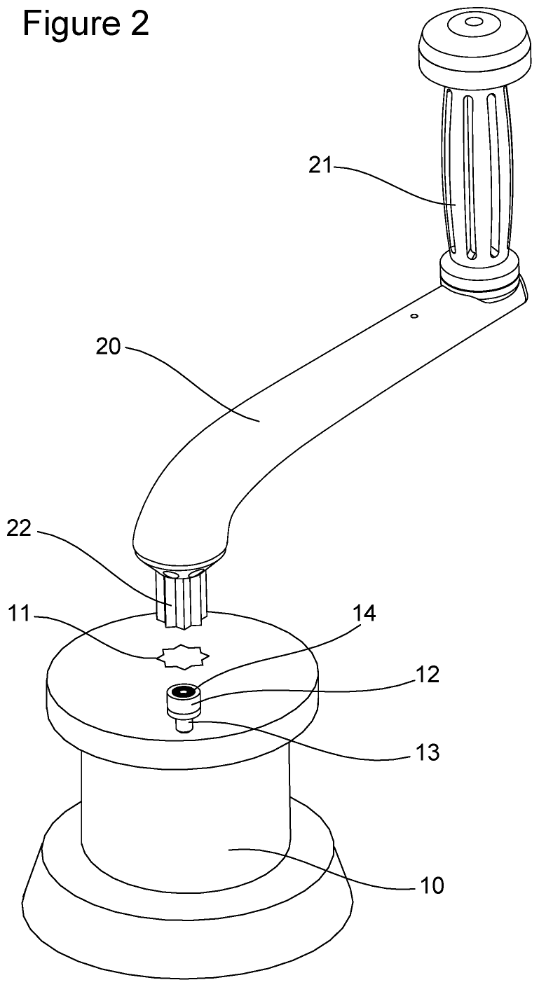

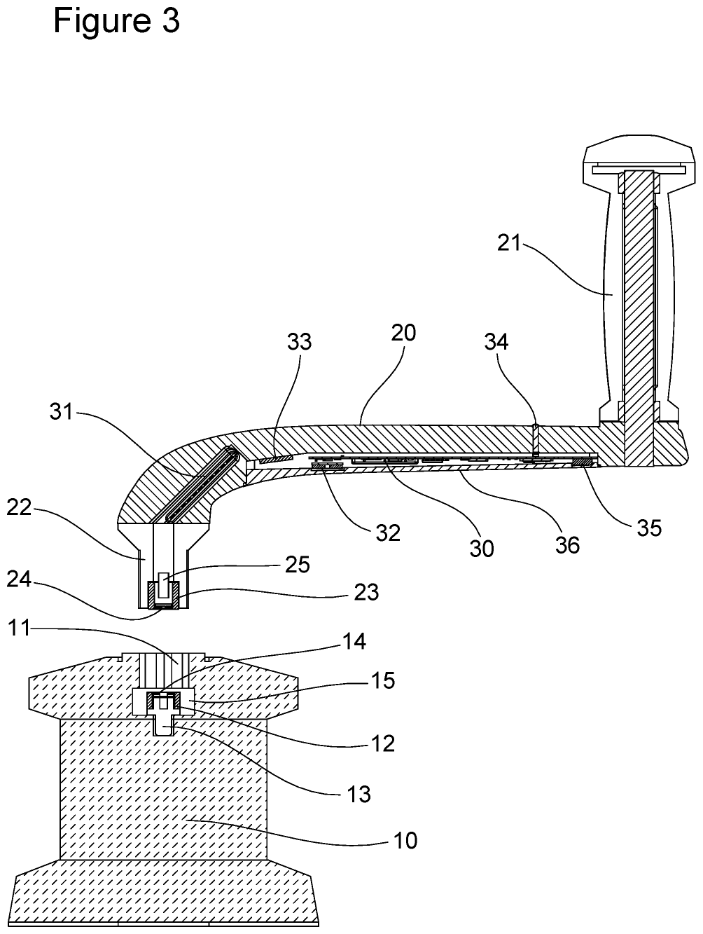

Referring to FIGS. 2 and 3, a preferred embodiment of the present invention is shown. The winch (10) can be a specially designed winch, but in this preferred embodiment the winch (10) is a standard winch that is prepared for being optionally driven by a motor mounted below the winch (10). In its central upper part, the winch (10) has an industry standard socket (11) connected to a shaft driving the winch drum.

The winch handle (20) shown in all the drawings includes the same configuration and features as industry standard winch handles. In its inner end the winch handle (20) of this preferred embodiment has a winch handle bit (22) protruding vertically down. Typically, the winch handle bit (22) has an 8-corner star shape or a 4-corner square shape. These shapes fit into the industry standard 8-cornered star shape of the winch socket (11). More or less all winches intended for use on a sailboat have a winch socket that follows this standard.

The winch socket (11) is typically 30-40 mm deep allowing the winch handle bit (22) of the winch handle (20) to mechanically mate with the socket (11). The depth and the shape of the socket (11) and the bit (22) secures that sufficient rotational force can be applied from the winch handle (20) to the winch (10) during operations.

To simplify the use of the winch handle as much as possible and to reserve the interior space of the handle for batteries and electronics, the present invention shows a winch handle (20) with no moving parts, no spring-loaded leavers or rotating knobs and no locking plates or pins. However, to prevent the winch handle (20) from unintentionally coming loose from the winch (10) it is temporarily mounted on, it is important that we have a locking system between the handle (20) and winch (10).

In the preferred embodiment of the present invention a locking system based on two magnetic members is shown. A first magnetic member, a magnet guide (23) made of a magnetically conductive material (e.g. ferromagnetic materials like iron) is mounted in the lower tip of the winch handle bit (22). A second magnetic member, a permanent magnet (12) (e.g. a neodymium magnet) is placed inside the socket (11) near the bottom. Typically, the different parts of a winch (10) are hold together by a screw accessible from inside the socket (11). In the preferred embodiment of the present invention this screw is replaced with a threaded magnet adapter (13) that in its lower end has threads corresponding to threads inside the winch, normally used by the screw holding the parts of the winch (10) together. In its upper end, the adapter (13) is adjusted to hold a circular-shaped permanent magnet (12). The shape and design of the magnet adapter (13) is adjusted to allow the winch handle bit (22) to fully mate with the winch socket (11). When the bit (22) is inserted into the socket (11), the magnet guide (23) should ideally be in full contact with the permanent magnet (12) to maximize the magnetic attraction force between the two magnetic members, i.e. the attraction force between the winch (10) and the winch handle (20).

It is this magnetic attraction force that constitutes the main part of the locking system of the present invention. In addition to the magnetic force, a friction force between the winch handle bit (22) and the winch socket (11) will arise if the winch handle is lifted in its outer end and thereby tilting the bit (11) inside the socket (12), effectively jamming any vertical movements of the bit (22), and the winch handle (20). To be able to release the winch handle (20) from the winch (10) the operator will have to pull the handle vertically upwards without introducing any tilt by lifting it in the inner end close to the winch handle bit (22). The (pure) vertical force will have to be greater than the weight of the winch handle (20) and the described magnetic attraction force combined.

It is possible to design systems with a magnetic attraction force between the two magnetic members ranging from a few Newtons (N) up to 100N or even as high as 200N. Tests have, however, shown that if the magnetic attraction force is too low, the winch handle (20) could unintentionally be dis-connected from the winch (10) and if it is too high it will make it unnecessary difficult for the operator to remove it from the winch (10). Ideal values for the attraction force have been found to be in the range from 10N up to 60N (1-6 kg).

In an alternative embodiment of the present invention the threaded magnet adapter (13) may be replaced by a separate structure that utilizes the winch socket void (15) that normally is used by locking pins or locking plates in traditional winch handles to lock the handle to a winch. In this embodiment the second magnetic member is attached to an expanding or rotating locking plate that either by spring-load or by active manipulation locks into position in the void (15) inside the winch socket (11). One of the advantages of this alternative embodiment is that the original screw that holds the components of the winch (10) together can be left in place and no modifications to the winch is needed.

In other embodiments of the present invention where the winch handle is not intended for controlling a power assist system or a motor connected to the winch, an alternative winch handle without space for electronics and magnetic sensors may be used. In such embodiments other configurations of the first and the second magnetic members may be used. If the first magnetic member in the winch handle bit is instead a permanent magnet it can magnetically interact with a ferromagnetic part of the second magnetic member or alternatively the second magnetic member could also be a permanent magnet.

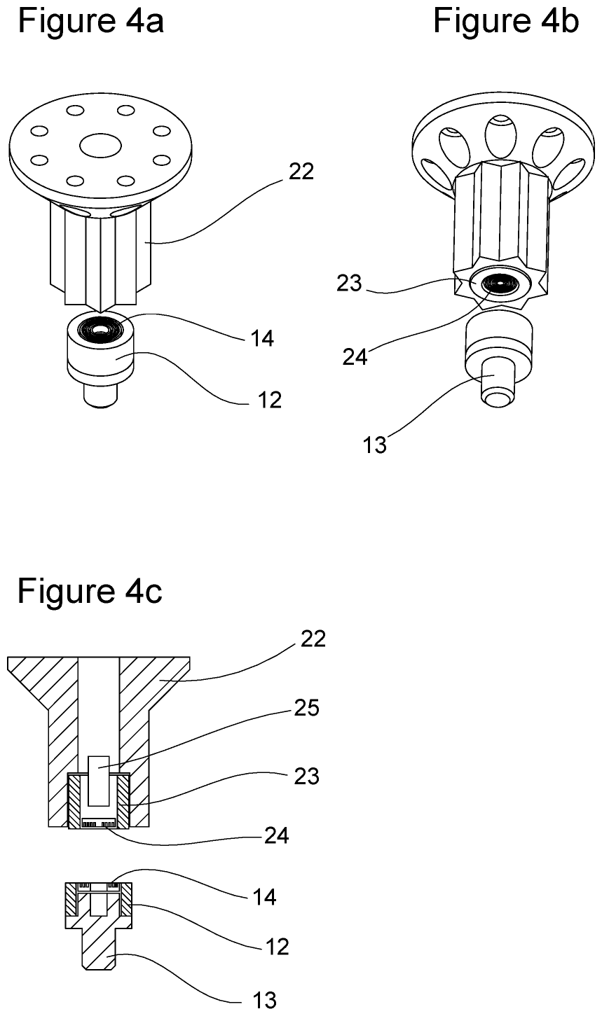

Returning to the preferred embodiment of the present invention and referring to FIGS. 3 and 4, more details of the invention are discussed.

To power the control electronics (30) embedded in the winch handle (20) the handle is equipped with a rechargeable battery (31). The rechargeable battery (31) is charged through a wireless charger (32) integrated in the control electronics (30). The rechargeable battery (31) is typically a lithium-polymer battery, but any kind of rechargeable battery could alternatively be used.

A sunlight visible LED light (34) is placed on the upper surface of the winch handle (20) to give visual feedback to the winch operator. The LED light (34) is controlled by the control electronics (30) and may use different colors and/or flashing patterns to report the status of the electronics (e.g., on, off, standby, radio link established, alarms).

The possibility to use the winch handle (20) of the present invention on other winches equipped with the same power assist system is an important feature of the system. However, since the winch handle (20) communicates with a motor control unit (as part of a power assist system connected to the winch, not shown in the figures) via a wireless radio link, it is important that the motor control unit only reacts to commands being sent from the winch handle (20) currently being temporarily mounted on the winch (10). There are several ways of securing that the winch handle (10) only sends valid commands to the motor control unit. One way is to use different frequencies on different winches and then have a frequency selector switch on the winch handle. One other way is to use “time of travel” techniques to only accept commands from a winch handle located very close to the winch. Yet another way is to place different unique patterns (magnetic or visual) into the winch socket and have a sensor in the winch handle bit that can read this pattern.

In the preferred embodiment of the present invention, however, the control electronics (30) picks up a unique address of the winch (10) from an (Near-Field Communication) NFC tag (14) placed in the winch socket (11) using an NFC antenna (24) in the winch handle bit (22). Before being mounted into the winch socket (11) the NFC tag (14) has been programmed with the unique address used by the motor control unit to validate commands from the wireless link. To save power and secure the stability of the system the NFC tag (14) is only read if a command is given to the control electronics (30). In this preferred embodiment, this command is initiated by a trigger signal sent from a magnetic sensor (25) mounted inside the winch handle bit (22) close to the magnet guide (23). In FIG. 4c a preferred position of the magnetic sensor (25) relative to the circular tube-shaped magnet guide (23) is shown. The position of the sensor (25) should be tuned to secure a safe and repeatable triggering of the sensor as soon as the winch handle bit (22) with the magnet guide (23) is fully mated into the winch socket (11). The trigger signal is also used as an activation command and is sent as long as the permanent magnet (12) in the winch socket (11) is detected by the sensor (25).

The magnetic sensor (25) is typically a non-latching hall effect sensor with characteristics matching the permanent magnet (12). Other kinds of magnetic sensors could be used in place of a hall effect sensor. Optical sensors, other kinds of proximity sensors and even a mechanical switch could alternatively be used to detect that the winch handle bit (22) is fully mated with the winch socket (11).

When the winch handle (20) is actively controlling a power assist system (not shown) connected to the winch (10), any loss of the trigger signal being sent from the magnetic sensor (25) is detected as a command to switch off the radio link and delete the unique winch address. This feature secures that all active control stops as soon as the winch handle (20) is released from the winch socket (11) and moved away.

During normal operation, any force being applied to the winch handle grip (21) is picked up by one or more strain gauge(s) (33) connected to the control electronics (30). The strain gauge (33) is typically firmly glued to a precisely prepared area close to the inner part of the winch handle (20) where the stress in the material of the winch handle (20) is at its highest during winch operations. Even if any stiff material (e.g., plastics, composites and metals) may be used to manufacture the winch handle (20), tests has shown that aluminum is well suited for this purpose. It is relatively stiff, light weight and bends evenly under mechanical stress, thus giving precise readings from the strain gauge (33). Based on the strain gauge readings the control electronics (30) calculates the turning force and direction applied to the winch (10) by the winch operator and adjusts the values based on calibration parameters stored by the microprocessor. These calibration parameters secure that different winch handles (of the present system) send the same commands to control the electric motor of the power assist system for a given applied force from the operator.

Based on the calculated direction and amount of force applied to the winch handle grip (21) the control electronics (30) sends a “target value” to the radio receiver in the power assist system via a radio antenna (35) in the winch handle (20). The unique address for the winch (10), being described earlier, is embedded in the target values and commands being sent to secure that the correct electric motor is controlled.

When the commands sent by the wireless radio link are received and validated by the control electronics in the power assist system, they are used to control the current fed to the motor in the system. A high manual force applied to the winch handle grip (21) is resulting in a high current being fed to the motor and thereby giving the winch operator a high amount of motorized assistance during the winching operation.

Finally, the winch handle (20) of the preferred embodiment of the present invention has a design feature that makes it less likely for lines and ropes to catch the winch handle (20) and pull it out of the winch socket (11). In FIGS. 2 and 3 the smooth and continues shape of the winch handle (20) and the electronics cover (36), from the winch handle bit (22) all the way out to the winch handle grip (21) can be seen. This shape secures that any line being caught under the winch handle (20) will be forced outwards and thereby lead to a tilting of the winch handle bit (22) inside the socket (11) if the line is tightened or lifted. As described earlier, the tilting jams the bit (22) in the socket (11), and together with the magnetic attraction force between the magnetic members in the winch handle (20) and winch (10) this secures that the winch handle (20) is not unintendedly disconnected from the winch (10) and lost.

The above description is only illustrative. Various alternatives and modifications can be devised by those skilled in the art without departing from the broader scope of the invention. Accordingly, the present invention is intended to include alternatives, modifications and variances which fall within the scope of the attached claims.

1. A winch handle locking system comprising a winch handle with a winch handle bit protruding down from an inner end of the winch handle, said winch handle bit being adapted to mate with an industry standard winch socket on top of a winch for sailboats, characterized in that
the winch handle bit, in its lower end, employs a first magnetic member modified to magnetically interact with a second magnetic member placed inside said winch socket, and
said second magnetic member further being mechanically fixed to the winch, inside the winch socket, at a position allowing the winch handle bit to mate with the winch socket, and
the said position and magnetic properties of the first and the second magnetic members are further being adjusted to secure an attraction force between the winch and the winch handle of between 10N and 60N when the winch handle is mounted on the winch.

2. A winch handle locking system according to claim 1, where the first magnetic member comprises a magnetic conductive material and where the second magnetic member is a permanent magnet.

3. A winch handle locking system according to claim 1, where the first magnetic member is a permanent magnet and where the second magnetic member comprises a magnetic conductive material.

4. A winch handle locking system according to claim 1, where both the first and the second magnetic members are permanent magnets.

5. A winch handle locking system according to claim 2, where the first magnetic member is a magnet guide made of said magnetic conductive material and where the magnet guide is interacting with a magnetic sensor mounted inside the winch handle bit, and where furthermore the properties of the magnet guide and the position and characteristics of the magnetic sensor is adjusted to secure that the permanent magnet triggers the sensor when the winch handle bit is fully mated into the winch socket.

6. A winch handle locking system according to claim 5, where the winch handle comprises electronics to control a motor connected to said winch and where the operation of the electronics is activated by an electric signal sent from the magnetic sensor when it is triggered.

7. A winch handle locking system according to claim 5, where the winch handle bit further comprises an NFC antenna tuned to activate and pick up a unique signal from an NFC tag mounted inside the winch socket.

8. A winch handle locking system according to claim 1, where the winch handle comprises a winch handle grip protruding upwards from an outer end of the winch handle and where the winch handle has a smooth upwards curved shape starting from the inner end protruding to the outer end.
